(19) United States
(12) Patent Application Publication
(10) Pub. No.: US 2026/0238740 A1
(43) Pub. Date: Aug. 13, 2026

(54) SELECTIVE MULTILINGUAL AUDIO AND VIDEO CAPTURE SYSTEM FOR EVENTS

(71) Applicant: RingCentral, Inc., Belmont, CA (US)

(72) Inventors: Mostafa Tofighbakhsh, Cupertino, CA (US); Kurram Taji, San Jose, CA (US); Homayoun Razavi, Belmont, CA (US)

(73) Assignee: RingCentral, Inc., Belmont, CA (US)

(21) Appl. No.: 19/538,408

(22) Filed: Feb. 12, 2026

Related U.S. Application Data
(60) Provisional application No. 63/757,632, filed on Feb. 12, 2025.

(51) Int. Cl. H04N 7/15

(52) U.S. Cl. CPC H04N 7/15

(57) ABSTRACT

The present disclosure provides a system for capturing and providing selective audio and video feeds from events. The system includes a plurality of camera arrays and microphone arrays associated with an event venue to capture real-time audio and video moments. A cloud-based mixer receives and processes the captured audio and video moments, organizing them into an AI database indexed and structured for real-time queries. A control plane processes user requests for real-time feeds and personalized experiences. The system renders audio and video moments that are streamed or broadcast to users based on their selections.

### BENEFIT CLAIM

This application is a continuation application and claims the benefit of priority to the U.S. application Ser. No. 63/757,632, which was filed on February 12^{th}, 2025, the entire contents of which is hereby incorporated by reference as if fully set forth herein.

### FIELD OF INVENTION

The present disclosure relates to audio and video capture systems for live events, and more particularly to a selective multilingual audio and video capture system for providing customizable real-time feeds to event attendees and remote viewers.

### BACKGROUND

Live events, such as sports matches, concerts, and other large gatherings, have long been a source of entertainment and excitement for attendees. These events often feature complex interactions between participants, officials, and spectators that contribute to the overall experience. However, traditional broadcast methods typically provide a limited perspective, focusing on select audio and video feeds that may not capture the full range of interesting moments occurring throughout the venue.

In recent years, advancements in audio and video technology have enabled more comprehensive capture of event experiences. Multiple camera angles and directional microphones can now record a wider array of interactions and occurrences. Despite these technological improvements, challenges remain in effectively delivering this wealth of content to viewers in a personalized and engaging manner.

One issue is the sheer volume of potential audio and video feeds available at any given moment during a large event. With numerous participants, multiple areas of interest, and thousands of spectators, it can be overwhelming to process and present all of this information simultaneously. Additionally, language barriers may prevent some viewers from fully appreciating certain interactions or conversations occurring during the event.

Furthermore, different viewers may have varying interests or preferences regarding which aspects of the event they wish to focus on. Some may want to hear on-field communications between players, while others might prefer to listen to crowd reactions or official discussions. The ability to cater to these diverse preferences while maintaining the overall cohesion and flow of the event experience presents a considerable challenge.

As events continue to grow in scale and complexity, there is an increasing desire for more immersive and customizable viewing experiences. Viewers, both in-person and remote, seek ways to feel more connected to the action and to access the specific moments and interactions that interest them most. This creates a need for innovative solutions that can capture, process, and deliver event content in flexible and user-centric ways.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for capturing and providing selective audio and video feeds from sporting events is provided. The system includes camera arrays and microphone arrays installed throughout a sports venue to capture real-time audio and video moments. The system also includes a cloud-based mixer configured to receive and process the captured audio and video moments. The mixer organizes the moments into an AI database that is indexed and structured for real-time queries. The system further includes a control plane that processes fan requests for real-time feeds and personalized experiences. The system renders audio and video moments that are streamed or broadcast to fans based on their selections.

According to other aspects of the present disclosure, the system may include one or more of the following features. The camera arrays and microphone arrays may be synchronized and may utilize beam forming technologies. The arrays may be placed or managed by humans, drones, or artificial intelligence. The system may include an edge private stadium wireless network that provides intelligent resource allocation to the arrays for capturing and uploading moments to the cloud mixer. The system may include on-device AI engines that apply filters and metadata to the captured moments. The cloud-based mixer may be architected with real-time AI databases that are vectorized and indexed for real-time queries. The system may include an admin portal that can dynamically optimize resource policies. The system may include an open API gateway for third-party applications. The system may include dashboards that monitor usage, provide insights, and analyze feedback from fans. The system may include multilingual translators that can translate audio feeds to different languages selected by fans.

According to another aspect of the present disclosure, a method for directing camera angles and audio beams to capture moments at sporting events is provided. The method includes using an AI algorithm to analyze surrounding crowd reactions and direct camera angles and audio beams based on the analysis to capture significant moments.

According to other aspects of the present disclosure, the method may include one or more of the following features. The method may include building prompt stories using a unique "Events Moment Model". The method may include using a recommendation engine to score "Event moments" based on historical records and uniqueness. The method may include incorporating real-time fan feedback loops to influence feature decoration for each event moment. The method may include applying real-time guardrails to filter privacy violations and replace them with AR effects or other features as moments are streamed to fans. The method may include creating searchable moments where captured moments are stored as objects characterized by logical popularity vectors for similarity searches.

According to one more aspects of the present disclosure, a non-transitory computer-readable medium storing instructions is provided. When executed by a processor, the instructions cause the processor to perform operations for capturing and providing selective audio and video feeds from sporting events.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system for capturing and providing selective audio and video feeds, according to aspects of the present disclosure.

FIG. 2 illustrates a block diagram of a conference management server, in accordance with example embodiments.

FIG. 3 illustrates a block diagram of an end-user device, according to an embodiment.

FIG. 4 illustrates a neural network system, according to an aspect of the present disclosure.

FIG. 5 illustrates a cloud service, in accordance with example embodiments.

FIG. 6 illustrates a flowchart of a method for capturing and providing selective audio and video feeds, in accordance with example embodiments.

### DETAILED DESCRIPTION

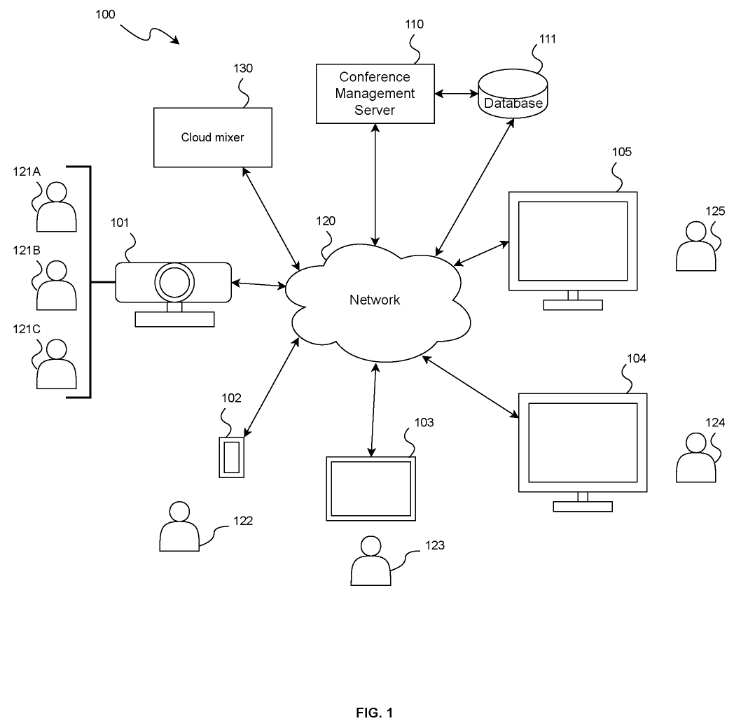

Referring to FIG. 1, a system 100 for capturing and providing selective audio and video feeds from events is illustrated. The system 100 may enable fans and other viewers to selectively switch between one or more real-time audio and video moments from various locations within an event venue, such as a stadium, arena, or other gathering space. In some cases, the system 100 may provide options for users to translate conversations and moments into different languages, accommodating fans who speak various languages and enhancing accessibility to captured content.

The system 100 may include a conference management server 110 connected to a network 120. The conference management server 110 may communicate with a database 111 for storing and retrieving data related to event moments and user preferences. In some cases, the database 111 may store indexed and structured moment data that can be retrieved based on user selections. The network 120 may serve as a communication hub, facilitating data flow between components of the system 100.

With continued reference to FIG. 1, a cloud mixer 130 may be connected to the network 120. The cloud mixer 130 may be configured to receive and process captured audio and video moments from various sources throughout an event venue. In some cases, the cloud mixer 130 may organize the captured moments into an AI database that is indexed and structured for real-time queries.

The system 100 may include several user devices connected to the network 120. A video conferencing device 101 may be associated with a first user 121A, a second user 121B, and a third user 121C, representing a group viewing scenario. A mobile device 102 may be associated with a fourth user 122, enabling mobile access to selective audio and video feeds. A first computer 103 may be associated with a fifth user 123, a second computer 104 may be associated with a sixth user 124, and a third computer 105 may be associated with a seventh user 125. Each of these devices may provide individual access points to the system 100, allowing users at various locations to access customized audio and video streams from events based on individual preferences.

In embodiments, the video conferencing device 101, the mobile device 102, the first computer 103, the second computer 104, and the third computer 105 may represent electronic devices present at the event venue and/or may represent electronic devices located in areas other than the event venue location. For example, mobile device 102 may represent thousands of mobile device present at a particular pro football stadium during a football match.

The system may include a plurality of camera arrays and microphone arrays (not pictured in FIG. 1) installed throughout an event venue to capture real-time audio and video moments. In some cases, the camera arrays and microphone arrays may be synchronized to operate in coordination, enabling simultaneous capture of visual and auditory content from specific locations within the venue. The synchronization between camera arrays and microphone arrays may allow for precise alignment of video feeds with corresponding audio content, facilitating coherent playback of captured moments.

The microphone arrays may utilize beam forming technologies to focus on specific areas or sources of sound within the event venue. Beam forming may involve the use of multiple microphone elements arranged in a specific configuration to create directional sensitivity patterns. In some cases, the beam forming technologies may enable the microphone arrays to isolate audio from particular zones, such as player conversations on a field, coach communications in huddle areas, referee exchanges, or fan reactions in specific sections of the venue. The directional capabilities of the beam forming technologies may allow for filtering of ambient stadium noise while capturing targeted audio content.

The camera arrays may be positioned at various locations throughout the event venue to capture video content from multiple angles and perspectives. In some cases, the camera arrays may be installed at fixed positions, such as along sidelines, in corners of playing fields, near team benches, or in spectator areas. The camera arrays may also be mounted on mobile platforms, such as drones, to provide dynamic capture capabilities that can follow moving subjects throughout the venue.

The placement of camera arrays and microphone arrays may be managed by humans, drones, or AI-based systems. In some cases, production policies may govern the positioning and operation of the arrays to capture moments according to predetermined criteria. The arrays may be configured to capture moments from various zones within the venue, including playing fields, courtside areas, team huddles, fan sections, referee positions, coach locations, and other areas of interest.

Each microphone within the microphone arrays may support immersive voice and audio services, and in some cases, each microphone may generate a distinct media file. The camera arrays may capture video content that corresponds to the audio captured by the microphone arrays, enabling the creation of synchronized audio-video moments. The captured moments may include exchanges between players during gameplay, communications between coaches and players, interactions between referees and team personnel, and reactions from fans in attendance.

The arrays may capture moments from various participants and locations, collectively referred to as moments. In some cases, the moments may include content from players communicating during active play, such as a player calling for a pass from a distant position on the field. The moments may also include audio and video from team huddles, where strategic discussions occur, subject to stadium policies regarding sharing of such content. The arrays may capture exchanges between referees and coaches during disagreements or disputed calls, which may be of interest to certain viewers.

The camera arrays may be configured to adjust angles and focus based on surrounding crowd reactions. In some cases, an AI algorithm may direct the camera angles and audio beams to capture moments based on detected crowd reactions in real-time. The arrays may respond to control signals generated based on external feeds, such as fan reactions from different sections of the venue, to capture relevant moments as events unfold.

The system may include an edge private stadium wireless network that provides intelligent resource allocation to the camera arrays, microphone arrays, and other capture devices for capturing and uploading moments to the cloud-based mixer. In some cases, the edge private stadium wireless network may comprise a 5G network, a WiFi network, or a combination of both technologies. The edge private stadium wireless network may be configured as a private network dedicated to the event venue, providing controlled and optimized connectivity for the various capture devices distributed throughout the venue.

The edge private stadium wireless network may include a 5G slice manager for optimizing resource allocation across the network. Network slicing may involve the partitioning of network resources into multiple virtual networks, each configured to meet specific performance requirements for different types of devices or applications. In some cases, the 5G slice manager may allocate dedicated network slices for different categories of capture devices based on their bandwidth requirements, latency sensitivity, and reliability needs.

The 5G slice manager may create a first network slice optimized for high-bandwidth video transmission from camera arrays. In some cases, this first network slice may be configured with enhanced data throughput capabilities to accommodate the large data volumes generated by high-resolution video capture. The first network slice may prioritize sustained bandwidth allocation to ensure continuous video streaming from fixed camera positions throughout the venue.

A second network slice may be allocated for audio transmission from microphone arrays. In some cases, the second network slice may be configured with low-latency characteristics to support real-time audio capture and transmission. The audio transmission requirements may differ from video transmission requirements, and the 5G slice manager may optimize the second network slice accordingly to minimize delay in audio content delivery.

The 5G slice manager may allocate a third network slice for drone-mounted capture devices. In some cases, drones carrying camera and audio beam technologies may require network connectivity that accommodates mobility throughout the venue airspace. The third network slice may be configured to support seamless handoff between network access points as drones move between different areas of the venue, maintaining continuous connectivity during flight operations.

In some cases, the 5G slice manager may dynamically adjust resource allocation based on real-time network conditions and capture demands. During periods of high activity, such as scoring plays or disputed calls, the 5G slice manager may increase bandwidth allocation to capture devices positioned in relevant areas of the venue. The dynamic resource allocation may enable the system to prioritize capture of moments that are likely to be of interest to viewers.

The edge private stadium wireless network may provide intelligent resource allocation that considers the location of capture devices within the venue. In some cases, capture devices positioned in areas with high moment capture activity may receive prioritized network resources compared to devices in less active areas. The intelligent resource allocation may adapt to changing conditions throughout an event, reallocating resources as the focus of activity shifts between different areas of the venue.

The 5G slice manager may also allocate network resources for control signaling between the capture devices and the cloud-based mixer. In some cases, a dedicated control slice may be configured with high reliability and low latency characteristics to ensure responsive communication of control commands to the capture devices. The control slice may carry instructions for adjusting camera angles, modifying audio beam directions, or activating specific capture modes based on detected events or user requests.

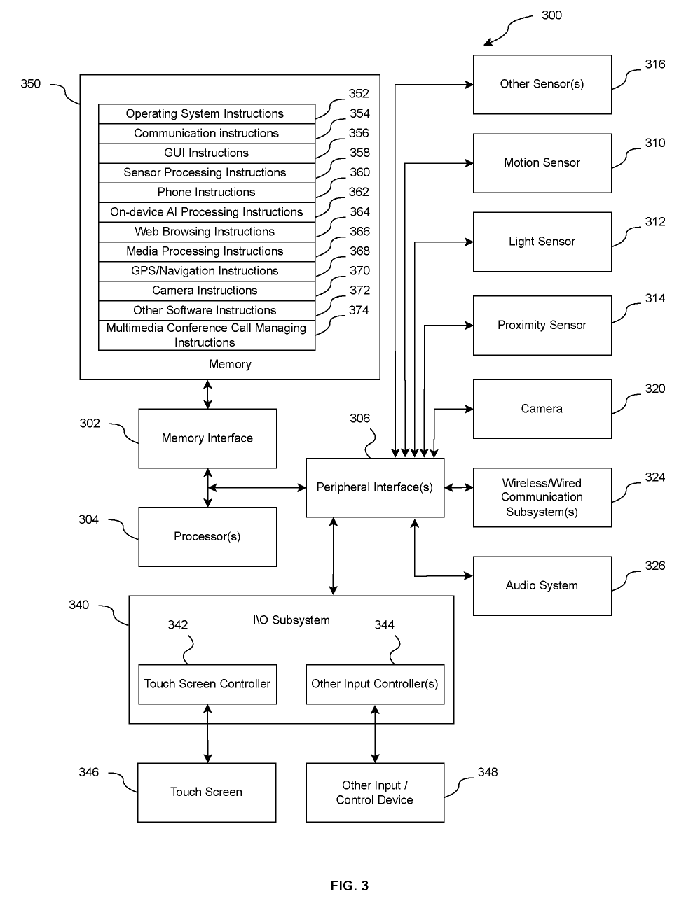

Referring to FIG. 3, a device 300 is illustrated that may represent an end-user device or a capture device configured with on-device AI capabilities. The device 300 may include a memory interface 302, a processor 304, and a peripheral interface 306 that facilitate communication between various components of the device 300. In some cases, the device 300 may be implemented as a smartphone, tablet, or dedicated capture device positioned throughout an event venue.

The device 300 may incorporate multiple sensors including a motion sensor 310, a light sensor 312, a proximity sensor 314, and other sensors 316. The motion sensor 310 may detect movement and orientation changes of the device 300, which may be used to adjust capture parameters based on device positioning. The light sensor 312 may measure ambient lighting conditions, enabling the device 300 to adapt capture settings for varying illumination levels within the venue. The proximity sensor 314 may detect nearby objects or subjects, which may inform capture decisions regarding focus and framing. The other sensors 316 may include environmental sensors that capture metadata such as temperature, humidity, or acoustic characteristics of the surrounding environment.

With continued reference to FIG. 3, the device 300 may include a camera 320 for capturing visual content. The camera 320 may be configured to capture video content that corresponds to audio captured by microphone arrays within the venue. In some cases, the camera 320 may operate in coordination with the camera arrays described previously, providing supplementary capture capabilities from additional vantage points.

A wireless/wired communication subsystem 324 may enable the device 300 to communicate with external systems and networks, including the network 120 and the cloud mixer 130. The wireless/wired communication subsystem 324 may support connectivity through the edge private stadium wireless network, enabling the device 300 to upload captured content and receive control commands. An audio system 326 may provide audio input and output capabilities for the device 300, enabling capture of audio content and playback of processed moments.

The device 300 may include an I/O subsystem 340 that manages input and output operations. The I/O subsystem 340 may connect to a touch screen controller 342 and other input controllers 344. The touch screen controller 342 may interface with a touch screen 346, providing a user interface for controlling capture operations and viewing captured content. The other input controllers 344 may connect to other input/control device 348, which may include physical buttons, dials, or external control interfaces.

A memory 350 within the device 300 may store various software instructions for operating the device 300 and implementing on-device AI processing capabilities. The memory 350 may contain operating system instructions 352 that manage the overall operation of the device 300. Communication instructions 354 may handle data transmission and reception between the device 300 and external systems. GUI instructions 356 may manage the graphical user interface displayed on the touch screen 346, enabling users to interact with capture and viewing functions.

The memory 350 may further include sensor processing instructions 358 that process data from the motion sensor 310, the light sensor 312, the proximity sensor 314, and the other sensors 316. In some cases, the sensor processing instructions 358 may analyze sensor data to generate metadata that characterizes the capture environment. Phone instructions 360 may enable telephony functions when the device 300 is implemented as a smartphone.

On-device AI processing instructions 362 stored in the memory 350 may provide artificial intelligence capabilities for processing captured content directly on the device 300. The on-device AI processing instructions 362 may enable the device 300 to apply filters and metadata to captured moments before transmission to the cloud mixer 130. In some cases, the on-device AI processing instructions 362 may implement machine learning algorithms that analyze captured audio and video content to identify relevant features, classify content types, and enhance content quality.

The on-device AI processing instructions 362 may enable the device 300 to apply noise reduction filters to captured audio content. In some cases, the noise reduction filters may isolate targeted audio, such as player communications, from ambient stadium noise. The on-device AI processing instructions 362 may also apply video enhancement filters that adjust brightness, contrast, and color balance based on lighting conditions detected by the light sensor 312.

The on-device AI processing instructions 362 may generate metadata that characterizes captured moments. In some cases, the metadata may include timestamp information indicating when the moment was captured, location data derived from the GPS/navigation instructions 368, and environmental data collected from the other sensors 316. The metadata may also include content classification tags generated by AI analysis of the captured audio and video content.

The memory 350 may also include web browsing instructions 364 that enable internet access, media processing instructions 366 that handle audio and video content processing, GPS/navigation instructions 368 that provide location-based services, and camera instructions 370 that control the camera 320. Other software instructions 372 may provide additional functionality, and multimedia conference call managing instructions 374 may enable the device 300 to participate in and manage multimedia conference calls in connection with the event capture and streaming system.

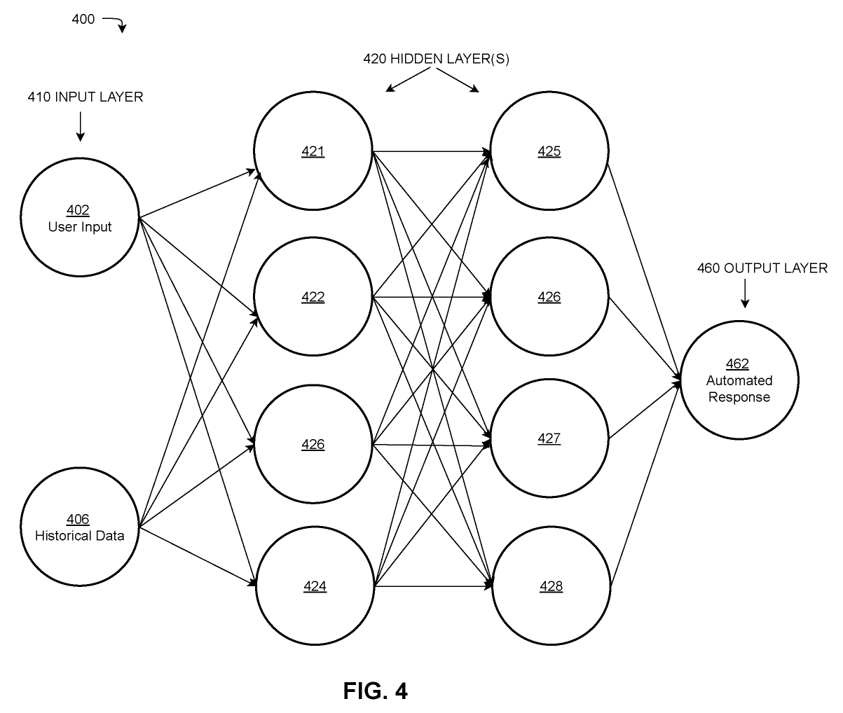

Referring to FIG. 4, a neural network system 400 is illustrated that may be implemented within the device 300 or within the cloud mixer 130 for processing inputs and generating automated responses. The neural network system 400 may include an input layer 410, hidden layers 420, and an output layer 460 arranged in a feedforward architecture.

The input layer 410 may comprise input nodes that receive data from different sources. A user input 402 node may receive information from users, such as preferences for specific types of moments or language selections. Historical data 406 may be received by another input node, providing previously stored data regarding past moments, user preferences, and content patterns. Both input nodes may be connected to the hidden layers 420, allowing the neural network system 400 to process current user requests in conjunction with historical information.

With continued reference to FIG. 4, the hidden layers 420 may include multiple interconnected nodes arranged in columns. A first column of hidden nodes may include a first hidden node 421, a second hidden node 422, a third hidden node 426, and a fourth hidden node 424. A second column of hidden nodes may include a fifth hidden node 425, the third hidden node 426, a seventh hidden node 427, and an eighth hidden node 428. The nodes within the hidden layers 420 may be interconnected with multiple pathways, allowing for complex data processing and feature extraction.

The output layer 460 may include an automated response 462 node that receives processed information from the second column of hidden nodes. The fifth hidden node 425, the third hidden node 426, the seventh hidden node 427, and the eighth hidden node 428 may all connect to the automated response 462 node, which generates the final output of the neural network system 400.

The neural network system 400 may operate by receiving the user input 402 and the historical data 406 through the input layer 410. This information may propagate through the hidden layers 420, where the interconnected nodes perform computations to extract features and patterns from the input data. The processed information may then flow to the output layer 460, where the automated response 462 is generated based on the combined analysis of user input and historical data.

In some cases, the neural network system 400 may be used by the on-device AI processing instructions 362 to determine which filters to apply to captured content. The neural network system 400 may analyze characteristics of captured audio and video content and generate recommendations for filter application based on content type, environmental conditions, and historical patterns of user preferences.

The on-device AI processing instructions 362 may use the neural network system 400 to classify captured moments into categories such as player communications, coach instructions, referee calls, or fan reactions. In some cases, the classification may inform the application of specific filters tailored to each content category. Player communications may receive enhanced voice isolation filters, while fan reactions may receive spatial audio processing to preserve the immersive quality of crowd sounds.

The on-device AI processing instructions 362 may also use the neural network system 400 to detect and flag moments of interest based on audio and video characteristics. In some cases, the neural network system 400 may identify moments where crowd reactions indicate a significant event, triggering enhanced capture and processing of content from that time period. The detection of moments of interest may inform the prioritization of content for transmission to the cloud mixer 130.

The metadata generated by the on-device AI processing instructions 362 may include feature vectors that characterize the content of captured moments. In some cases, the feature vectors may be used for similarity searches within the database 111, enabling users to find moments with similar characteristics to previously viewed content. The feature vectors may be generated by the neural network system 400 based on analysis of audio waveforms, video frames, and associated sensor data.

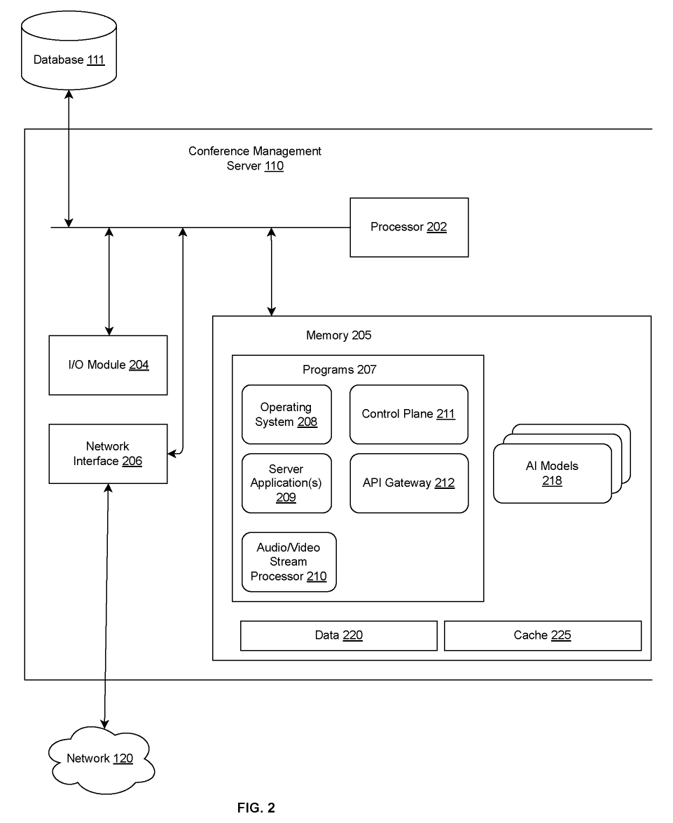

Referring to FIG. 2, the conference management server 110 and associated components are illustrated. The conference management server 110 may be connected to the database 111 and the network 120. In some embodiments, database 111 may represent a database provided in a cloud environment. The conference management server 110 may include a processor 202 that manages the operations of the server. An I/O module 204 may handle input and output operations, while a network interface 206 may provide connectivity to the network 120.

The conference management server 110 may include a memory 205 that stores various components for processing and managing captured moments. Within the memory 205, programs 207 may be stored, which may include an operating system 208 that manages the overall operation of the conference management server 110. The programs 207 may also include server application(s) 209 that provide functionality for handling user connections and managing event data.

With continued reference to FIG. 2, the memory 205 may contain an audio/video stream processor 210 that handles the processing of audio and video streams captured from event venues. The audio/video stream processor 210 may receive captured moments from the cloud mixer 130 and process the moments for delivery to user devices. In some cases, the audio/video stream processor 210 may apply additional processing to moments based on user preferences and device capabilities.

The memory 205 may also contain a control plane 211 that processes user requests for real-time feeds and personalized experiences. The control plane 211 may receive requests from user devices such as the video conferencing device 101, the mobile device 102, the first computer 103, the second computer 104, and the third computer 105. In some cases, the control plane 211 may route requests to appropriate processing components and coordinate the delivery of selected moments to requesting users.

An API gateway 212 may be stored within the memory 205 to facilitate integration with third-party applications. The API gateway 212 may expose interfaces that allow external applications to access captured moments and related data. In some cases, third-party developers may use the API gateway 212 to build applications that aggregate, enhance, and render audio and video feeds for specialized use cases.

The memory 205 may contain AI models 218 that are used for analyzing captured moments and providing recommendations. The AI models 218 may implement the neural network system 400 to classify captured moments into categories such as player communications, coach instructions, referee calls, or fan reactions. In some cases, the classification performed by the AI models 218 may inform the application of specific filters tailored to each content category. Player communications may receive enhanced voice isolation filters, while fan reactions may receive spatial audio processing to preserve the immersive quality of crowd sounds.

The memory 205 may further include data 220 for storing processed information related to captured moments, user preferences, and system configurations. A cache 225 may be included within the memory 205 for improving query performance and response times. In some cases, the cache 225 may store frequently accessed moment data and user preference information to reduce latency when responding to user requests.

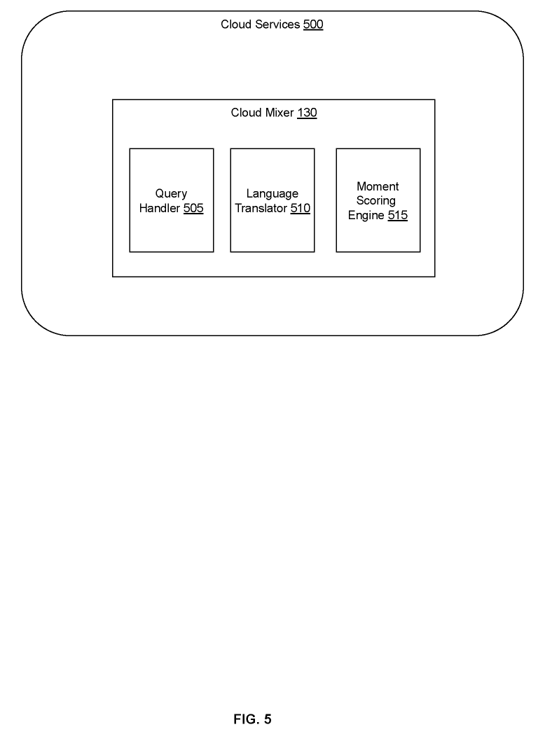

Referring to FIG. 5, cloud services 500 and associated components are illustrated. The cloud services 500 may encompass the cloud mixer 130, which serves as a processing component for handling audio and video moments captured from event venues. The cloud mixer 130 may represent one or more cloud servers configured to receive, process, and organize captured moments.

The cloud mixer 130 may be architected with real-time AI databases that are vectorized and indexed for real-time queries. In some cases, the real-time AI databases may store captured moments along with associated metadata, enabling efficient retrieval based on various search criteria. The vectorized structure of the databases may support similarity searches based on content characteristics, allowing users to find moments with similar attributes to previously viewed content.

With continued reference to FIG. 5, the cloud mixer 130 may contain a query handler 505 that processes user requests for real-time feeds and personalized experiences. The query handler 505 may receive requests from the control plane 211 and retrieve relevant moments from the real-time AI databases. In some cases, the query handler 505 may optimize query execution to minimize latency and provide responsive access to captured moments.

The cloud mixer 130 may contain a language translator 510 that provides multilingual translation capabilities. The language translator 510 may enable audio feeds to be translated into different languages selected by users. In some cases, the language translator 510 may employ real-time translation algorithms to convert spoken words from one language to another with minimal delay, accommodating fans who speak various languages.

A moment scoring engine 515 may be contained within the cloud mixer 130 to evaluate captured event moments based on various criteria. The moment scoring engine 515 may score moments based on historical records and uniqueness, enabling the system to identify moments that represent notable events. In some cases, the moment scoring engine 515 may analyze crowd feedback and AI model outputs to determine the relative significance of captured moments.

The cloud mixer 130 may organize captured moments into the database 111 indexed and structured for real-time queries. In some cases, the moments may be indexed based on attributes including timestamp, location, participant identities, and event type. The indexing may enable users to search for moments based on specific criteria, such as moments involving particular players, moments from specific areas of the venue, or moments occurring during particular time periods.

The cloud mixer 130 may create searchable moments characterized by logical popularity vectors for similarity searches. In some cases, the popularity vectors may be derived from user engagement metrics, crowd reactions, and AI analysis of content characteristics. The popularity vectors may enable the query handler 505 to recommend moments that are similar to content that users have previously viewed or that have received positive feedback from other viewers.

The real-time AI databases used by the cloud mixer 130, such as database 111, may store moments as objects characterized by multiple attributes. In some cases, each moment object may include the captured audio and video content, associated metadata generated by on-device AI processing, classification tags assigned by the AI models 218, and scoring information generated by the moment scoring engine 515. The structured organization of moment objects may enable efficient retrieval and processing based on user requests.

The cloud mixer 130 may apply rules and policies for privacy to captured moments before making the moments available to users. In some cases, real-time guardrails may filter privacy violations and replace sensitive content with augmented reality effects or other features as moments are streamed to fans. The privacy policies may be configured through an admin portal that allows administrators to dynamically optimize resource policies based on venue requirements and regulatory considerations.

In an embodiment, the cloud services 500 or/and cloud mixer 130 may be integrated into the conference management server 110. In this embodiment, query handler 550, language translator 510, and moment scoring engine 515 may be implemented as separate neural network systems (like the neural network system 400), or as dedicated AI models 218 within the conference management server 110.

Referring to FIG. 2, the control plane 211 stored within the memory 205 of the conference management server 110 may process fan requests for real-time feeds and personalized experiences. The control plane 211 may receive requests from user devices connected to the network 120, including the video conferencing device 101, the mobile device 102, the first computer 103, the second computer 104, and the third computer 105. In some cases, the control plane 211 may maintain session state information for each connected user, tracking current selections and preferences throughout an event.

The control plane 211 may provide an interface through which fans can select from various moments captured throughout an event venue. In some cases, fans may select audio streams from specific zones within the venue, such as courtside areas, fan sections, referee positions, or team huddle locations. The control plane 211 may process these selection requests and coordinate with the query handler 505 within the cloud mixer 130 to retrieve and deliver the requested content streams.

With continued reference to FIG. 2, the control plane 211 may enable fans to customize their viewing experience by selecting multiple simultaneous audio and video feeds. In some cases, a fan may choose to view a primary video feed showing gameplay while simultaneously listening to an audio stream capturing player communications on the field. The control plane 211 may manage the synchronization of multiple selected streams to ensure coherent playback of combined audio and video content.

The control plane 211 may process requests for language translation of audio feeds. In some cases, when a fan selects a moment containing dialogue in a language different from the fan's preferred language, the control plane 211 may route the audio content through the language translator 510 within the cloud mixer 130. The control plane 211 may maintain language preference settings for each user, automatically applying translation to selected content based on stored preferences.

Referring to FIG. 3, the device 300 may provide a user interface through which fans interact with the control plane 211 to customize their viewing experience. The touch screen 346 may display selectable options representing different zones, participants, and content types available for viewing. In some cases, the GUI instructions 356 stored in the memory 350 may render a graphical interface that presents available moments organized by category, such as player moments, coach moments, referee moments, or fan moments.

The device 300 may enable fans to submit requests to the control plane 211 through the wireless/wired communication subsystem 324. In some cases, fans may use touch gestures on the touch screen 346 to select specific audio streams, switch between video feeds, or adjust volume levels for different audio sources. The touch screen controller 342 may process these touch inputs and generate corresponding request messages for transmission to the control plane 211.

With continued reference to FIG. 3, the device 300 may provide real-time feedback capabilities that influence the capture and processing of moments. In some cases, fans may provide feedback through the other input/control device 348, indicating preferences for specific types of content or rating the quality of viewed moments. The communication instructions 354 may transmit this feedback to the control plane 211, which may aggregate feedback from multiple users to inform content prioritization and recommendation algorithms.

The control plane 211 may process fan requests for spatial audio experiences that replicate on-field or courtside environments. In some cases, the audio system 326 of the device 300 may receive processed audio streams that include spatial positioning information, enabling fans to experience directional audio that corresponds to the positions of sound sources within the venue. The control plane 211 may coordinate with the audio/video stream processor 210 to render spatial audio content based on fan device capabilities and preferences.

The control plane 211 may enable fans to create personalized viewing profiles that store preferences for future events. In some cases, the database 111 may store user profile information including preferred zones, favorite players, language settings, and audio mixing preferences. When a fan connects to the system 100 for a subsequent event, the control plane 211 may retrieve stored preferences and automatically configure the viewing experience based on the stored profile.

The control plane 211 may process requests for real-time moment notifications based on fan-specified criteria. In some cases, fans may configure alerts for specific types of moments, such as moments involving particular players or moments from specific areas of the venue. The control plane 211 may monitor incoming moments from the cloud mixer 130 and generate notifications to fans when moments matching their specified criteria become available.

The device 300 may enable fans to share selected moments with other users through the control plane 211. In some cases, the multimedia conference call managing instructions 374 may facilitate shared viewing sessions where multiple fans can simultaneously view the same selected moments. The control plane 211 may coordinate the delivery of synchronized content streams to multiple devices participating in a shared viewing session.

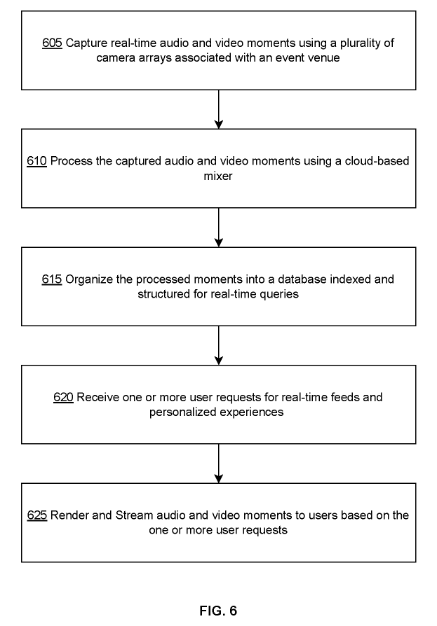

Referring to FIG. 6, a method 600 for capturing and providing selective audio and video feeds from events is illustrated. The method 600may be performed by components of the system 100, including the cloud mixer 130, the conference management server 110, and the user devices 101, 102, 103, 104, and 105. In some cases, the method 600may enable fans to receive customized audio and video content based on individual preferences and selections.

The method 600 may begin with a step 605, where real-time audio and video moments are captured using a plurality of camera arrays and microphone arrays (e.g., camera and microphone of the video conference device 101) associated with an event venue. The camera arrays and microphone arrays may be positioned at various locations within the venue to capture content from multiple zones, including playing fields, sidelines, team benches, and spectator areas. For example, during a basketball game, the camera arrays may capture video of players on the court while the microphone arrays with beam forming technologies isolate player communications from ambient crowd noise, enabling capture of a player calling for a pass from a teammate.

The method 600 may proceed to a step 610, where the captured audio and video moments are processed using the cloud mixer 130. The cloud mixer 130 may receive the captured moments through the network 120 and apply processing operations including noise filtering, metadata enrichment, and content classification. For example, the cloud mixer 130 may process captured audio from a referee-coach exchange by applying voice isolation filters to enhance speech clarity and adding metadata tags identifying the participants and the timestamp of the interaction.

With continued reference to FIG. 6, the method 600 may continue to a step 615, where the processed moments are organized into the database 111 indexed and structured for real-time queries. The indexing may be based on attributes including timestamp, location, participant identities, and event type, enabling efficient retrieval of moments based on user search criteria. For example, moments captured during a football game may be indexed by zone (such as end zone, sideline, or huddle area), by participant (such as specific player names or referee identifiers), and by event type (such as touchdown celebration, disputed call, or coach instruction), allowing fans to search for specific content categories.

The method 600 may proceed to a step 620, where one or more user requests for real-time feeds and personalized experiences are received. The control plane 211 may receive requests from user devices such as the mobile device 102, the first computer 103, or the video conferencing device 101 through the network 120. For example, a fan using the mobile device 102 may submit a request to receive an audio stream capturing player communications on the field while simultaneously viewing a video feed showing gameplay from a sideline camera angle.

The method 600 may conclude with a step 625, where audio and video moments are rendered and streamed to users based on the one or more user requests. The audio/video stream processor 210 may render the requested content and deliver the content to the requesting user devices through the network 120. For example, when a fan requests to hear coach instructions in a language different from the original spoken language, the language translator 510 within the cloud mixer 130 may translate the audio content before the audio/video stream processor 210 renders and streams the translated audio along with corresponding video content to the fan's device.

The rendering and streaming operations performed at the step 625 may accommodate various streaming scenarios based on fan preferences. In some cases, a fan may request a single audio stream from a specific zone, such as courtside audio during a basketball game, which the system 100 may render and stream as a standalone audio feed synchronized with a standard broadcast video feed. In other cases, a fan may request multiple simultaneous audio streams, such as player communications combined with crowd reactions from a specific section of the venue, which the audio/video stream processor 210 may mix and render as a combined audio experience.

The streaming scenarios may also include spatial audio experiences that replicate on-field or courtside environments. In some cases, the audio/video stream processor 210 may render audio content with spatial positioning information that corresponds to the physical locations of sound sources within the venue. For example, a fan viewing a soccer match may receive a spatial audio stream where player voices appear to originate from positions corresponding to the players' locations on the field, creating an immersive experience that simulates being present at the venue.

The method 600 may support streaming scenarios where fans at the venue receive different content than remote fans. In some cases, fans attending an event in person may use the mobile device 102 to access supplementary audio streams that enhance the live experience, such as isolated referee communications or translated coach instructions. Remote fans viewing through the video conferencing device 101 or the first computer 103 may receive rendered content that combines multiple audio and video sources to replicate aspects of the in-person experience.

Referring to FIG. 2, the conference management server 110 may include administrative features that enable dynamic optimization of system resources, integration with third-party applications, and monitoring of system performance. The server application(s) 209 stored within the memory 205 may implement an admin portal that provides administrators with interfaces for configuring and managing the system 100. In some cases, the admin portal may be accessed through a web-based interface that allows administrators to view and modify system settings from remote locations.

The admin portal may enable administrators to dynamically optimize resource policies based on event requirements and venue configurations. In some cases, administrators may use the admin portal to configure capture policies that govern which zones within a venue receive prioritized capture resources. For example, during a football game, an administrator may configure the system 100 to allocate additional capture resources to end zone areas during scoring opportunities, ensuring that celebration moments are captured with enhanced quality.

With continued reference to FIG. 2, the admin portal may provide interfaces for configuring privacy policies that govern the filtering and processing of captured moments. In some cases, administrators may define rules that specify which types of content require privacy filtering before being made available to fans. For example, an administrator may configure a policy that applies audio masking to team huddle communications while allowing visual content from huddle areas to be streamed without modification.

The admin portal may enable administrators to configure language translation settings for the system 100. In some cases, administrators may specify which languages are available for translation and configure quality thresholds for translated content. The admin portal may also allow administrators to prioritize translation resources for specific language pairs based on anticipated fan demographics for particular events.

The API gateway 212 stored within the memory 205 may facilitate integration with third-party applications by exposing programmatic interfaces for accessing captured moments and system functionality. In some cases, the API gateway 212 may implement representational state transfer (REST) interfaces that allow external applications to query the database 111 for available moments, retrieve moment content, and submit processing requests. Third-party developers may use the API gateway 212 to build applications that aggregate, enhance, and render audio and video feeds for specialized use cases.

The API gateway 212 may provide authentication and authorization mechanisms that control access to system resources by third-party applications. In some cases, the API gateway 212 may implement token-based authentication that requires third-party applications to present valid credentials before accessing protected resources. The API gateway 212 may also enforce rate limiting policies that prevent individual applications from consuming excessive system resources.

With continued reference to FIG. 2, the API gateway 212 may expose interfaces that enable third-party applications to access moment scoring data generated by the AI models 218. In some cases, third-party applications may retrieve scoring information to build recommendation engines that suggest moments to users based on popularity metrics and content characteristics. For example, a third-party sports analytics application may use the API gateway 212 to retrieve moment data and scoring information to generate highlight compilations based on moments that received high engagement scores.

The API gateway 212 may enable third-party applications to submit custom processing requests for captured moments. In some cases, third-party applications may request specific audio processing operations, such as enhanced noise reduction or custom spatial audio rendering, to be applied to retrieved moments. The API gateway 212 may route these processing requests to the audio/video stream processor 210 and return processed content to the requesting application.

The server application(s) 209 may implement dashboards that provide visibility into system usage, performance metrics, and fan engagement patterns. In some cases, the dashboards may display real-time statistics regarding the number of active users, the volume of moments being captured and processed, and the distribution of fan selections across different content categories. Administrators may use the dashboards to monitor system health and identify areas requiring attention or optimization.

The dashboards may display metrics related to network resource utilization within the event venue. In some cases, the dashboards may show bandwidth consumption by different categories of capture devices, latency measurements for content delivery to user devices, and error rates for content transmission operations. For example, during a live event, an administrator may use the dashboards to identify that camera arrays in a particular section of the venue are experiencing elevated latency, prompting investigation and remediation of network connectivity issues in that area.

With continued reference to FIG. 2, the dashboards may provide insights into fan engagement patterns and content preferences. In some cases, the dashboards may display statistics regarding which zones and content types receive the most fan selections, which moments receive the highest engagement scores, and which language translation options are most frequently requested. For example, the dashboards may reveal that fans attending a particular soccer match frequently select audio streams from the area near the team benches, indicating interest in coach communications during gameplay.

The dashboards may enable administrators to analyze feedback from fans and identify opportunities for improving the viewing experience. In some cases, the dashboards may aggregate user ratings and comments regarding moment quality, translation accuracy, and overall satisfaction with the system 100. The data 220 stored within the memory 205 may include historical feedback information that enables trend analysis across multiple events.

The cache 225 within the memory 205 may support dashboard performance by storing frequently accessed metrics and aggregated statistics. In some cases, the cache 225 may maintain pre-computed summaries of usage patterns and engagement metrics, enabling the dashboards to display information with minimal latency. The cache 225 may be updated periodically based on new data stored in the database 111, ensuring that dashboard displays reflect current system state while maintaining responsive performance.

The admin portal may enable administrators to configure alert thresholds that trigger notifications when system metrics exceed specified bounds. In some cases, administrators may configure alerts for conditions such as elevated error rates, degraded content quality scores, or unusual patterns in fan engagement. For example, an administrator may configure an alert that triggers when the average latency for content delivery exceeds a specified threshold, enabling prompt investigation of potential network or processing bottlenecks.

Referring to FIG. 5, the language translator 510 within the cloud mixer 130 may provide multilingual translation capabilities that enable audio feeds to be translated into different languages selected by fans. The language translator 510 may employ real-time translation algorithms to convert spoken words from one language to another with minimal delay, accommodating fans who speak various languages and enhancing accessibility to captured audio content from events.

The language translator 510 may receive audio content from captured moments and process the audio content to generate translated output in a target language specified by a fan. In some cases, the language translator 510 may implement speech recognition algorithms that convert spoken audio into text representations, followed by machine translation algorithms that convert the text from a source language to a target language, and speech synthesis algorithms that generate audio output in the target language. The combination of these processing stages may enable the language translator 510 to provide translated audio that preserves the meaning and context of original spoken content.

With continued reference to FIG. 5, the language translator 510 may support translation between multiple language pairs based on fan demographics and event characteristics. In some cases, the language translator 510 may be configured to translate audio content from languages commonly spoken by players and coaches into languages commonly spoken by fans attending or viewing particular events. For example, during a soccer match where players communicate in French, a fan who prefers to hear content in Farsi may select Farsi as a target language, and the language translator 510 may translate the captured French audio into Farsi for delivery to that fan.

The language translator 510 may process audio content from various zones within an event venue, including player communications on the field, coach instructions from sideline areas, and referee exchanges during disputed calls. In some cases, the language translator 510 may receive audio content that has been processed by the query handler 505 based on fan selections, and the language translator 510 may apply translation to the selected content before the content is rendered and streamed to the requesting fan. For example, when a fan selects an audio stream capturing a coach providing instructions to players in Spanish, the language translator 510 may translate the Spanish audio into English or another language preferred by the fan.

The language translator 510 may maintain context information across multiple utterances within a captured moment to improve translation accuracy. In some cases, the language translator 510 may analyze preceding dialogue to inform translation of subsequent statements, enabling more accurate rendering of conversations that reference earlier content. For example, when translating a conversation between a referee and a coach regarding a disputed call, the language translator 510 may use context from the initial exchange to inform translation of follow-up statements that reference the original dispute. In some embodiments, the language translator 510 may broadcast critical moments to registered fans based on previous translation requests. For example, in a soccer match two Spanish speaking star players may get into a shoving match where words are exchanged in Spanish. The microphone arrays may detect the argument in Spanish between the two players, and may automatically broadcast translated versions of their argument to registered fans, where each fan receives the translated version in their preferred language.

With continued reference to FIG. 5, the language translator 510 may apply domain-specific translation models that are trained on sports terminology and communication patterns. In some cases, the language translator 510 may implement specialized vocabulary mappings for different sports, enabling accurate translation of technical terms, play names, and position references that may have sport-specific meanings. For example, when translating basketball player communications, the language translator 510 may recognize and accurately translate terms such as pick-and-roll, fast break, or zone defense into equivalent terms in the target language.

The language translator 510 may provide translation with varying levels of latency based on fan preferences and content characteristics. In some cases, fans may select a low-latency translation mode that prioritizes speed over translation refinement, enabling near-real-time delivery of translated content during live gameplay. In other cases, fans may select a higher-quality translation mode that introduces additional processing delay to enable more refined translation output. The control plane 211 may communicate fan preferences to the language translator 510 to configure appropriate translation parameters.

The language translator 510 may handle audio content that includes multiple speakers communicating in different languages. In some cases, captured moments may include exchanges between participants who speak different languages, such as a referee communicating with players from different national teams. The language translator 510 may detect language transitions within the audio content and apply appropriate translation for each language segment, generating unified translated output in the fan's selected target language.

The moment scoring engine 515 within the cloud mixer 130 may interact with the language translator 510 to prioritize translation resources for moments that receive high engagement scores. In some cases, the moment scoring engine 515 may identify moments that are generating significant fan interest, and the cloud mixer 130 may allocate additional translation processing resources to ensure that translated versions of high-interest moments are available with minimal delay. For example, when the moment scoring engine 515 identifies that a post-game interview with a winning player is receiving high engagement, the language translator 510 may prioritize translation of that interview content into multiple target languages.

The language translator 510 may generate translated audio that preserves characteristics of the original speaker's voice and delivery style. In some cases, the language translator 510 may implement voice cloning or voice adaptation techniques that render translated speech with tonal qualities and speaking patterns that approximate the original speaker. For example, when translating an emotional post-game statement from a coach, the language translator 510 may generate translated audio that conveys similar emotional intensity and speaking cadence as the original statement.

The query handler 505 may coordinate with the language translator 510 to manage translation requests from multiple fans simultaneously. In some cases, the query handler 505 may aggregate translation requests for common language pairs and route the requests to shared translation processing resources, reducing computational overhead when multiple fans request the same content translated into the same target language. For example, when multiple fans request translation of a referee explanation from English to Spanish, the query handler 505 may coordinate a single translation operation and distribute the translated output to all requesting fans.

The language translator 510 may store translated versions of captured moments in the database 111 for subsequent retrieval. In some cases, when a moment has been translated into a particular target language, the translated version may be indexed and stored alongside the original content, enabling rapid retrieval when subsequent fans request the same translation. The storage of translated content may reduce processing latency for popular moments that are frequently requested in common target languages.

Referring to FIG. 1, the components of the system may operate in coordination to capture, process, and deliver personalized event experiences to fans located at various positions relative to an event venue. The camera arrays and microphone arrays distributed throughout the venue may continuously capture audio and video content from multiple zones, while the edge private stadium wireless network transports the captured content to the cloud-based mixer for processing. The conference management server may coordinate the delivery of processed content to user devices based on fan selections received through the control plane.

During a live sporting event, the system may operate through a continuous cycle of capture, processing, organization, and delivery. The camera arrays may capture video content from fixed positions along sidelines, in corners of playing fields, near team benches, and in spectator areas, while mobile camera platforms such as drones may follow moving subjects throughout the venue. The microphone arrays may simultaneously capture audio content using beam forming technologies to isolate specific sound sources from ambient venue noise. The captured audio and video content may be transmitted through the edge private stadium wireless network to the cloud-based mixer, where the content is processed, organized, and made available for fan selection.

With continued reference to FIG. 1, the system may support multiple simultaneous viewing scenarios during a single event. A first group of fans using the video conferencing device may select a shared viewing experience that combines a primary broadcast video feed with supplementary audio streams capturing player communications on the field. A fan using the mobile device may independently select a different combination of audio and video feeds, such as courtside video combined with translated coach instructions. Fans using the first computer, the second computer, and the third computer may each select personalized content combinations based on individual preferences, with the conference management server coordinating delivery of distinct content streams to each device through the network.

The system may adapt to changing conditions throughout an event by dynamically adjusting capture priorities and processing resources. During periods of routine gameplay, the camera arrays and microphone arrays may operate according to standard capture policies that distribute resources across multiple zones within the venue. When significant events occur, such as scoring plays, disputed calls, or celebrations, the system may detect increased crowd reactions and reallocate capture resources to focus on areas of heightened activity. The cloud-based mixer may prioritize processing of content captured during significant events, and the moment scoring engine may assign elevated scores to moments that correspond to detected crowd reactions.

Referring to FIG. 6, the method for capturing and providing selective audio and video feeds may be illustrated through an example scenario during a basketball game. At the step where real-time audio and video moments are captured, the camera arrays positioned around the court may capture video of players during active gameplay, while the microphone arrays may isolate audio of player communications, such as a point guard calling out a play to teammates. The captured content may be transmitted to the cloud-based mixer through the edge private stadium wireless network.

At the step where the captured audio and video moments are processed, the cloud-based mixer may apply noise reduction filters to the captured audio to enhance the clarity of player voices while reducing ambient crowd noise. The cloud-based mixer may also apply metadata tags that identify the players involved in the captured communication, the timestamp of the moment, and the location on the court where the communication occurred. The on-device AI engines within the capture devices may have applied initial filtering and metadata enrichment before transmission, and the cloud-based mixer may perform additional processing to prepare the content for organization and retrieval.

With continued reference to FIG. 6, at the step where the processed moments are organized into the database, the cloud-based mixer may index the captured player communication based on multiple attributes. The moment may be indexed by timestamp to enable retrieval based on game clock time, by location to enable retrieval based on court position, by participant identities to enable retrieval based on player names, and by event type to enable retrieval as a player communication moment. The indexing may enable fans to search for specific content, such as all communications involving a particular player during a specific quarter of the game.

At the step where user requests for real-time feeds and personalized experiences are received, a fan using the mobile device may submit a request to receive an audio stream capturing player communications while viewing a video feed showing gameplay from a baseline camera angle. The control plane may receive this request through the network and determine which content streams satisfy the fan's selection criteria. The control plane may query the cloud-based mixer to identify available player communication audio streams and baseline video feeds that correspond to the current game time.

At the step where audio and video moments are rendered and streamed to users, the audio/video stream processor may retrieve the requested player communication audio and baseline video content from the cloud-based mixer. The audio/video stream processor may synchronize the audio and video streams to ensure that the player communications align temporally with the corresponding gameplay video. The synchronized content may be rendered and streamed to the fan's mobile device through the network, enabling the fan to hear player communications while viewing gameplay from the selected camera angle.

The system may support scenarios where fans request translated content during live events. For example, during a soccer match where players communicate in Portuguese, a fan who prefers to hear content in Japanese may select Japanese as a target language through the user interface on the mobile device. When the fan selects an audio stream capturing player communications, the control plane may route the request to the cloud-based mixer, which may process the captured Portuguese audio through the language translator to generate Japanese output. The translated audio may be rendered and streamed to the fan's device with minimal delay, enabling the fan to understand player communications in the preferred language.

Referring to FIG. 1, the system may support scenarios where fans at the venue receive different content than remote fans viewing through connected devices. A fan attending a football game in person may use the mobile device to access supplementary audio streams that enhance the live experience, such as isolated referee communications during a disputed call. The fan may hear the referee explanation through headphones connected to the mobile device while simultaneously experiencing the ambient sounds of the venue directly. Remote fans viewing through the video conferencing device or computers may receive rendered content that combines multiple audio and video sources, such as a primary broadcast video feed combined with spatial audio that simulates the acoustic environment of being present at the venue.

The system may support scenarios involving team huddles and strategic communications, subject to venue policies regarding the sharing of such content. During a timeout in a basketball game, the camera arrays positioned near team benches may capture video of a coach providing instructions to players, while the microphone arrays may capture the audio of the coach's instructions. The cloud-based mixer may process this content and apply privacy policies configured through the admin portal. In some cases, the privacy policies may allow the video content to be made available to fans while applying audio masking to protect strategic communications. In other cases, the venue policies may allow both audio and video content from huddle areas to be made available, enabling fans to hear coach instructions and observe player reactions.

With continued reference to FIG. 1, the system may support scenarios involving referee and coach exchanges during disputed calls. When a coach approaches a referee to dispute a call, the camera arrays may capture video of the exchange while the microphone arrays isolate the audio of the conversation from surrounding crowd noise. The cloud-based mixer may process this content and make the moment available for fan selection. Fans interested in understanding the dispute may select the audio stream capturing the referee-coach exchange, and the system may deliver the content to the requesting fans' devices. If the exchange occurs in a language different from a fan's preferred language, the language translator may translate the audio content before delivery.

The system may support scenarios where multiple fans participate in shared viewing sessions. A group of fans located in different geographic locations may use the video conferencing device and computers to participate in a shared viewing session coordinated through the conference management server. The fans may collectively select content streams to view together, such as a primary video feed combined with audio streams capturing player communications. The conference management server may coordinate the delivery of synchronized content to all devices participating in the shared session, enabling the fans to experience the same content simultaneously despite being in different locations.

Referring to FIG. 6, the system may support post-event scenarios where fans access archived moments after an event has concluded. The database may retain indexed and organized moments from completed events, enabling fans to search for and retrieve specific content based on various criteria. A fan may use the first computer to search for moments involving a particular player during a specific game, and the query handler may retrieve matching moments from the database. The fan may select moments to view, and the audio/video stream processor may render and stream the archived content to the fan's device. The language translator may translate archived audio content into the fan's preferred language if the original content was captured in a different language.

The system may support scenarios where third-party applications access captured moments through the API gateway. A sports analytics application may use the API gateway to retrieve moment data and scoring information from completed events, enabling the application to generate highlight compilations based on moments that received high engagement scores. A fan engagement application may use the API gateway to access real-time moment data during live events, enabling the application to provide notifications to fans when moments matching specified criteria become available. The API gateway may authenticate and authorize requests from third-party applications, ensuring that access to system resources is controlled according to configured policies.

With continued reference to FIG. 1, the system may support scenarios where administrators monitor and adjust system operation during live events. Administrators may use the dashboards to observe real-time metrics regarding capture device performance, network resource utilization, and fan engagement patterns. When the dashboards indicate that capture devices in a particular area of the venue are experiencing connectivity issues, administrators may use the admin portal to adjust network resource allocation or dispatch personnel to investigate the issue. When the dashboards indicate that fans are frequently requesting content from a particular zone, administrators may use the admin portal to allocate additional capture resources to that zone.

The system may support scenarios involving environmental metadata that enhances the context of captured moments. The capture devices may include sensors that measure environmental conditions such as temperature, humidity, and ambient noise levels. This environmental metadata may be associated with captured moments and stored in the database alongside the audio and video content. Fans may use the environmental metadata to understand the conditions under which moments were captured, and third-party applications may use the environmental metadata to provide contextual information about captured content.

A number of implementations have been described. Nevertheless, it will be understood that various modifications may be made without departing from the spirit and scope of the disclosure. Accordingly, other implementations are within the scope of the following claims.

1. A system for capturing and providing selective audio and video feeds from events, comprising:
a plurality of camera arrays and microphone arrays associated with an event venue to capture real-time audio and video moments;
a cloud-based mixer configured to receive and process the captured audio and video moments, wherein the mixer organizes the moments into an AI database indexed and structured for real-time queries; and
a control plane that processes user requests for real-time feeds and personalized experiences, wherein the system renders audio and video moments that are streamed or broadcast to users based on their selections.

2. The system of claim 1, wherein the camera arrays and microphone arrays are synchronized and utilize beam forming technologies.

3. The system of claim 1, further comprising an edge private stadium wireless network that provides intelligent resource allocation to the arrays for capturing and uploading moments to the cloud-based mixer.

4. The system of claim 3, wherein the edge private stadium wireless network includes a 5G slice manager for optimizing resource allocation.

5. The system of claim 1, further comprising on-device AI engines that apply filters and metadata to the captured moments.

6. The system of claim 1, wherein the cloud-based mixer is architected with real-time AI databases that are vectorized and indexed for real-time queries.

7. The system of claim 1, further comprising multilingual translators configured to translate audio feeds to different languages selected by users.

8. A method for capturing and providing selective audio and video feeds from events, comprising:
capturing real-time audio and video moments using a plurality of camera arrays and microphone arrays associated with an event venue;
processing the captured audio and video moments using a cloud-based mixer;
organizing the processed moments into an AI database indexed and structured for real-time queries;
receiving user requests for real-time feeds and personalized experiences; and
rendering and streaming audio and video moments to users based on their selections.

9. The method of claim 8, wherein the camera arrays and microphone arrays utilize beam forming technologies to focus on specific areas or sources of sound within the event venue.

10. The method of claim 8, further comprising applying filters and metadata to the captured moments using on-device AI engines.

11. The method of claim 8, wherein organizing the processed moments into the AI database comprises indexing the moments based on attributes including timestamp, location, participant identities, and event type.

12. The method of claim 11, further comprising creating searchable moments characterized by logical popularity vectors for similarity searches.

13. The method of claim 8, further comprising translating audio feeds to different languages selected by users using multilingual translators.

14. The method of claim 13, wherein translating audio feeds comprises employing real-time translation algorithms to convert spoken words from one language to another with minimal delay.

15. A non-transitory computer-readable medium storing instructions that, when executed by a processor, cause the processor to perform operations for providing selective audio and video feeds from events, the operations comprising:
receiving real-time audio and video moments captured by a plurality of camera arrays and microphone arrays associated with an event venue;
processing the captured audio and video moments;
organizing the processed moments into an AI database indexed and structured for real-time queries;
processing user requests for real-time feeds and personalized experiences; and
rendering and streaming audio and video moments to users based on their selections.

16. The non-transitory computer-readable medium of claim 15, wherein processing the captured audio and video moments comprises applying filters and adding metadata using on-device AI engines.

17. The non-transitory computer-readable medium of claim 15, wherein organizing the processed moments into the AI database comprises indexing the moments based on attributes including timestamp, location, participant identities, and event type.

18. The non-transitory computer-readable medium of claim 17, wherein the operations further comprise creating searchable moments characterized by logical popularity vectors for similarity searches.

19. The non-transitory computer-readable medium of claim 15, wherein the operations further comprise translating audio feeds to different languages selected by users using multilingual translators.

20. The non-transitory computer-readable medium of claim 19, wherein translating audio feeds comprises employing real-time translation algorithms to convert spoken words from one language to another with minimal delay.
